(19) United States
(12) Patent Application Publication
(10) Pub. No.: US 2022/0402460 A1
(43) Pub. Date: Dec. 22, 2022

(54) WIPER CONTROLLING METHOD AND APPARATUS

(71) Applicant: DY-ESSYS CORP., Incheon (KR)

(72) Inventors: Min Wook PARK, Incheon (KR); Je Min MUN, Incheon (KR); Ki Chan LEE, Incheon (KR)

(73) Assignee: DY-ESSYS CORP., Incheon (KR)

(21) Appl. No.: 17/824,888

(22) Filed: May 25, 2022

(30) Foreign Application Priority Data
Jun. 22, 2021 (KR) 10-2021-0081037

(51) Int. Cl. B60S 1/08

(52) U.S. Cl. CPC B60S 1/0818

(57) ABSTRACT

A wiper controlling method and apparatus are provided. The wiper controlling apparatus obtains an area of a Pulse Width Modulation (PWM) control signal generated for driving a wiper motor while a wiper moves in a pre-defined section and controls a speed of the wiper based on a result of comparing the area with at least one pre-defined reference value.

### CROSS-REFERENCE TO RELATED APPLICATION

This application is based on and claims priority under 35 U.S.C. § 119 to Korean Patent Application No. 10-2021-0081037, filed on Jun. 22, 2021, in the Korean Intellectual Property Office, the disclosure of which is incorporated by reference herein in its entirety.

### BACKGROUND

### 1. Field

One or more embodiments relate to a wiper controlling method apparatus, and more particularly, to a wiper controlling method and apparatus for controlling a wiper by identifying a load applied to a wiper motor.

### 2. Description of the Related Art

A wiper configured to wipe away raindrops, etc. by moving in right and left directions is provided on a windshield of a vehicle. An automatic wiper device is configured to automatically recognize rainwater on a windshield of a vehicle and to control a wiping speed according to the amount of rainwater. The wiper may also operate according to a speed manually set by a user. A load applied to a wiper motor may vary according to a frictional force between the windshield and the wiper, a speed of the wiper, etc., and when an excessive load is applied to the wiper motor, the wiper motor may be damaged. Therefore, it is required to control the speed of the wiper not only simply according to the amount of rainwater on the windshield of the vehicle, but also by taking into account a real-time load applied to the wiper motor, in order to protect the wiper motor.

### SUMMARY

The technical objective to be accomplished by embodiments of the disclosure is to provide a wiper controlling method and apparatus for preventing damage to a wiper motor by identifying, in real time, a load applied to the wiper motor, without additionally including a sensor.

Additional aspects will be set forth in part in the description which follows and, in part, will be apparent from the description, or may be learned by practice of the presented embodiments of the disclosure.

According to one or more embodiments, a wiper controlling method performed by a wiper controlling apparatus includes: obtaining an area of a Pulse Width Modulation (PWM) control signal generated for driving a wiper motor while a wiper moves in a pre-defined section; comparing the area with at least one pre-defined reference value; and controlling a speed of the wiper based on a result of the comparison of the area with the at least one pre-defined reference value.

According to one or more embodiments, a wiper controlling apparatus includes: an area calculating unit configured to obtain an area of a Pulse Width Modulation (PWM) control signal generated for driving a wiper motor while a wiper moves in a pre-defined section; a comparison unit configured to compare the area with at least one pre-defined reference value; and a controlling unit configured to control a speed of the wiper based on a result of the comparison of the area with the at least one pre-defined reference value.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram of components of an example of a wiper driving device according to an embodiment;

FIG. 2 is a diagram of an example of a Pulse Width Modulation (PWM) control signal according to an embodiment;

FIG. 3 is a flowchart of an example of a wiper controlling method according to an embodiment;

FIG. 4 is a diagram of an example of obtaining an area of a PWM control signal, according to an embodiment;

FIG. 5 is a diagram of an example of a method of obtaining an area of a PWM control signal generated in a wiper movement section, according to an embodiment; and

FIG. 6 is a diagram of components of an example of a wiper controlling apparatus according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, a wiper controlling method and apparatus according to an embodiment will be described in detail by referring to the accompanying drawings.

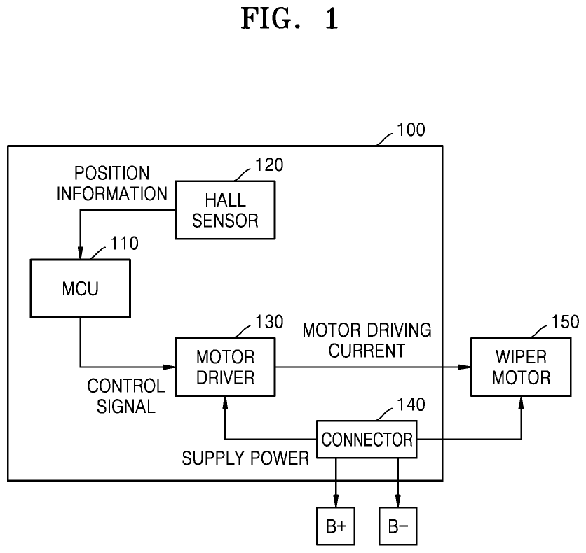

FIG. 1 is a diagram of components of an example of a wiper driving device 100 according to an embodiment.

Referring to FIG. 1, the wiper driving device 100 may include a micro-control unit (MCU) 110, a hall sensor 120, and a motor driver 130. In addition, the wiper driving device 100 may further include various components, such as a connector 140 configured to receive power, etc. However, the present embodiment is described mainly based on the components illustrated in the drawing, for convenience of explanation.

The hall sensor 120 may identify a position of a wiper and provide the identified position to the MCU 110. For example, the hall sensor 120 may identify whether the wiper is in a parking position or whether the wiper is in a lowermost position LRP or an uppermost position URP in a movement section of the wiper. There are various methods of identifying a current position of a wiper, according to the related art, and the hall sensor 120 is not limited to its name and may be implemented as various techniques for identifying the position of the wiper according to the related art.

The MCU 110 may generate and provide, to the motor driver 130, a Pulse Width Modulation (PWM) control signal for controlling a wiper. The MCU 110 may use various methods of generating the PWM control signal according to the related art. For example, in the case of an automatic wiper automatically performing motion according to the amount of rainwater on a windshield of a vehicle, the MCU 110 may calculate a speed of the wiper based on information about the amount of rainwater received from an external device (for example, a rainwater sensor, etc.) and may generate a PWM control signal for controlling the calculated speed of the wiper. As another example, when a user manually inputs a speed of a wiper, etc., the MCU 110 may generate a PWM control signal for controlling the wiper to have the speed of the wiper that is manually input. The method of generating the PWM control signal to control the speed of the automatic wiper or the manual wiper, the method being performed by the MCU 110, is already well known. Thus, it will not be additionally described.

The motor driver 130 may provide a motor driving current to a wiper motor 150, according to the PWM control signal provided from the MCU 110. The wiper motor 150 may have different rotation speeds according to the amount of motor driving current, and thus, may control the speed of the wiper connected to the wiper motor 150.

The MCU 110 may control the wiper motor 150 via feedback such that the wiper may move at a speed that is automatically or manually set. The configuration of controlling the wiper motor via feedback by using the PWM control signal, such that the speed of the wiper reaches a pre-defined target speed, is already well-known, and thus, its description is omitted. Furthermore, the present embodiment may be implemented by using various methods of controlling the speed of the wiper by using the PWM control signal according to the related art and is not necessarily limited to the description herein.

With respect to controlling of the wiper to have the target speed, a load applied to the wiper motor 150 may vary according to various external environmental factors, such as a frictional force between the windshield of the vehicle and the wiper, a vehicle speed, impurities, etc. For example, when the wiper moves at a speed A, a load applied to the wiper motor 150 on a rainy day and a load applied to the wiper motor 150 on a sunny day may be different from each other.

As a method of identifying the load applied to the wiper motor 150, there may be (a) method(s) of using a current sensor measuring the amount of current transmitted to the wiper motor 150 and/or a temperature sensor measuring a temperature generated in the wiper motor 150. However, in this case, additional sensors are required, and thus, a structure of the wiper driving device 100 may become complex and manufacturing costs may be increased.

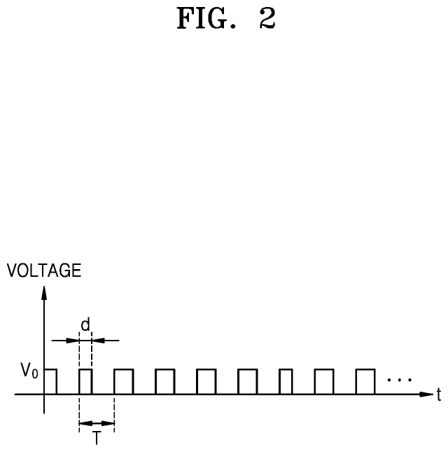

Thus, according to the present embodiment, a method of identifying the load applied to the wiper motor 150 based on the PWM control signal generated by the MCU 110 is provided. This aspect is described in detail hereinafter initially by referring to FIG. 2. Also, a wiper controlling apparatus according to an embodiment, to be described hereinafter, may be implemented as a portion of the MCU 110 of the wiper driving device 100 of FIG. 1 or as a separate device connected to the MCU 110 of FIG. 1. However, hereinafter, for convenience of explanation, a case where the wiper controlling apparatus is implemented as a portion of the MCU 110 of FIG. 1 is mainly described.

FIG. 2 is a diagram of an example of a PWM control signal according to an embodiment.

Referring to FIG. 2, the PWM control signal may include a pulse composed of an on-signal section and an off-signal section and may control the amount of motor driving current transmitted to the wiper motor 150 based on a length (that is, a duty cycle) of the on-signal section to a cycle T of the pulse.

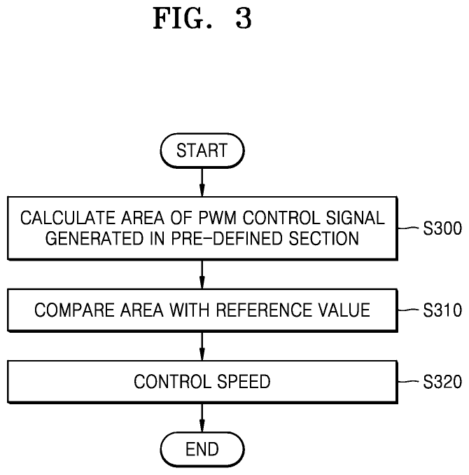

FIG. 3 is a flowchart of an example of a wiper controlling method according to an embodiment.

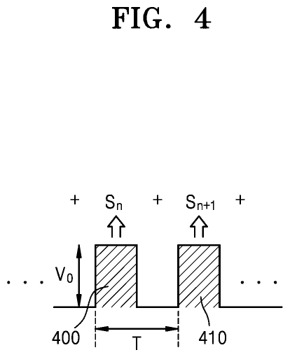

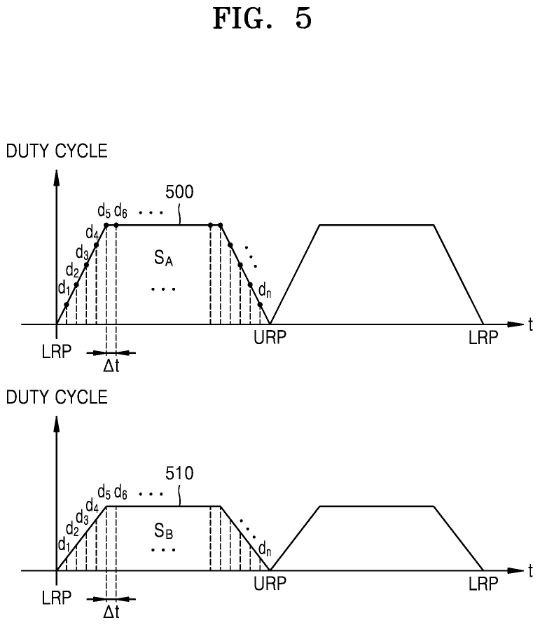

Referring to FIG. 3, the wiper controlling apparatus may calculate an area of a PWM control signal generated while a wiper moves in a pre-defined section (S300). For example, the wiper controlling apparatus may calculate the area of the PWM control signal, which is generated by the MCU while the wiper moves from a lowermost position to an uppermost position in a movement section of the wiper. Examples of calculating the area are illustrated in FIGS. 4 and 5.

The wiper controlling apparatus may compare the area of the PWM control signal with at least one pre-defined reference value (S310) and may control a speed of the wiper based on a result of the comparison of the area of the PWM control signal with the at least one pre-defined reference value (S320). For example, when only one reference value is defined, the wiper controlling apparatus may deem that a large load is applied to the wiper motor when the area of the PWM control signal is greater than the reference value, and the wiper controlling apparatus may decelerate the speed of the wiper by a pre-defined value (or rate (for example, decreasing by 10% from a current speed) or may change the speed of the wiper to a pre-defined speed.

For example, in a situation where an automatic wiper is controlled to have a speed A according to the amount of rainwater, when the area of the PWM control signal is greater than the reference value, the wiper controlling apparatus may control the wiper to have a speed B, which is lower than the speed A. When the area of the PWM control signal decreases to a value below the reference value, the wiper controlling apparatus may stop the controlling intervention to restore the speed of the wiper to the speed A. That is, when the MCU 110 of the wiper driving device 100 receives a control command from the wiper controlling apparatus while the MCU 110 of the wiper driving device 100 controls the speed of the wiper according to a conventional method, the MCU 110 may firstly process the command of the wiper controlling apparatus.

Alternatively, the wiper controlling apparatus may identify that a windshield of a vehicle is in a dry state when the area of the PWM control signal is greater than the reference value and may identify that the windshield of the vehicle is in a wet state when the area of the PWM control signal is equal to or less than the reference value. The wiper controlling apparatus may generate various controlling values. For example, the wiper controlling apparatus may provide a value about the identified state of the windshield to an external device or may use this value to variously control the speed of the wiper.

FIG. 4 is a diagram of an example of obtaining an area of a PWM control signal, according to an embodiment.

Referring to FIG. 4, each pulse of the PWM control signal includes on-signal sections 400 and 410 and an off-signal section. The wiper controlling apparatus may obtain the area of the PWM control signal by accumulating areas of the on-signal sections 400 and 410 of each pulse. For example, the wiper controlling apparatus may obtain the areas of the on-signal sections 400 and 410 of the pulses, by using a frequency (that is, a pulse cycle T) of the PWM control signal, a duty cycle of each pulse, and a magnitude of a signal of each pulse (that is, a height Vo). When the pulse cycle T of the PWM control signal and the signal magnitude Vo are fixed values, the wiper controlling apparatus may obtain the area of each pulse by identifying only the duty cycle of each pulse.

FIG. 5 is a diagram of an example of a method of obtaining an area of a PWM control signal generated in a wiper movement section, according to an embodiment.

Referring to FIG. 5, the wiper controlling apparatus may obtain the area of the PWM control signal generated while a wiper moves in a pre-defined section. According to the present embodiment, for convenience of explanation, an example of obtaining the area of the PWM control signal generated by the MCU 110 of the wiper driving device 100 of FIG. 1 while the wiper moves from the lowermost position LRP to the uppermost position URP, is illustrated. However, the pre-defined section for obtaining the area of the PWM control signal may be variously configured according to an embodiment. For example, the pre-defined section may include a section in which a wiper performs one-time reciprocating motion, a predetermined section in which the wiper performs uniform motion, or a predetermined angular section.

When the number of pulses included in the PWM control signal generated by the MCU 110 while the wiper moves from the lowermost position LRP to the uppermost position URP is n, the wiper controlling apparatus may calculate the area of the PWM control signal by accumulating the areas of the on-signal sections of each pulse, as described with reference to FIG. 4.

According to another embodiment, the wiper controlling apparatus may identify a duty cycle, etc. of the PWM control signal generated in the wiper movement section (for example, the section from the lowermost position to the uppermost position), based on a predetermined cycle Δt. Here, the cycle Δt based on which the wiper controlling apparatus may identify the duty cycle of the PWM control signal may be different from a pulse cycle T of the PWM control signal. For example, the cycle Δt based on which the wiper controlling apparatus may identify the duty cycle, etc. may be longer than the pulse cycle T of the PWM control signal. The wiper controlling apparatus may accumulate the duty cycles d1, d2, . . . and do (that is, the areas of the on-signal sections of respective pulses of FIG. 4) of the PWM control signal, the duty cycles being identified for respective cycles, to calculate the area (S=d1+d2+ . . . +dn) of the PWM control signal.

When the wiper driving device 100 controls the wiper to operate at a uniform speed, a frictional force between the wiper and the windshield, etc. may be changed according to an external environmental factor, and thus, a load applied to the wiper motor may be changed. For example, a distribution 500 of the duty cycles of the PWM control signal generated when the wiper is driven at a speed A on a sunny day (that is, when the windshield is in a dry state) may be different from a distribution 510 of the duty cycles of the PWM control signal generated when the wiper is driven at the speed A on a rainy day (that is, when the windshield is in a wet state) (S_{A}>S_{B}), due to the frictional force. In other words, when the frictional force of the wiper increases, the MCU 110 may have to maintain the speed A by supplying more currents to the wiper motor by increasing the duty cycle of the PWM control signal, but when the frictional force of the wiper decreases, the MCU 110 may maintain the speed A by supplying less current to the wiper motor by decreasing the duty cycle of the PWM control signal.

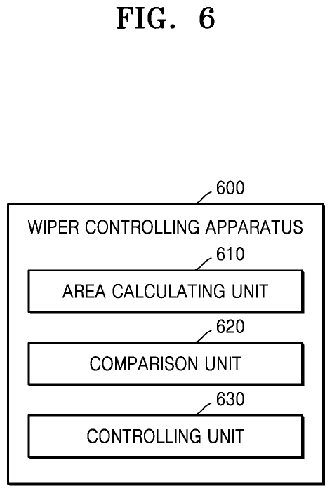

FIG. 6 is a diagram of components of an example of a wiper controlling apparatus 600, according to an embodiment.

Referring to FIG. 6, the wiper controlling apparatus 600 may include an area calculating unit 610, a comparison unit 620, and a controlling unit 630. Each component of the wiper controlling apparatus 600 may be implemented as software, loaded on a memory, and executed by a processor. For example, the wiper controlling apparatus 600 according to the present embodiment may be implemented as a portion of the MCU 110 of FIG. 1.

While a wiper moves in a pre-defined section, the area calculating unit 610 may obtain an area of a PWM control signal generated for driving a wiper motor. Examples of the method of obtaining the area of the PWM control signal are illustrated in FIGS. 4 and 5.

The comparison unit 620 may compare the area of the PWM control signal with at least one pre-defined reference value.

The controlling unit 630 may control a speed of the wiper based on a result of the comparison between the area of the PWM control signal and the at least one pre-defined reference value. For example, when a plurality of reference values are defined, the controlling unit 630 may variously control the speed of the wiper according to which of the plurality of reference values the area of the PWM control signal corresponds to.

The disclosure may also be realized as a computer-readable code in a computer-readable recording medium. The computer-readable recording medium includes all types of recording devices in which data which may be read by a computer system is stored. Examples of the computer-readable recording medium include read-only memories (ROMs), random-access memories (RAMs), CD-ROMs, solid state drive (SSD) storage devices, optical data storage devices, etc. The computer-readable recording medium can also be distributed over network coupled computer systems so that the compute readable code is stored and executed in a distributed fashion.

As described above, according to the one or more of the above embodiments of the disclosure, damage to the wiper motor may be prevented by identifying a load applied to the wiper motor using a software manner, without adding an additional hardware component. As another example, whether the windshield is in a wet state or a dry state may be identified.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A wiper controlling method performed by a wiper controlling apparatus, the wiper controlling method comprising:
obtaining an area of a Pulse Width Modulation (PWM) control signal generated for driving a wiper motor while a wiper moves in a pre-defined section;
comparing the area with at least one pre-defined reference value; and
controlling a speed of the wiper based on a result of the comparison of the area with the at least one pre-defined reference value.

2. The wiper controlling method of claim 1, wherein the obtaining of the area includes obtaining a pulse area based on a duty cycle of the PWM control signal generated while the wiper moves from a lowermost position to an uppermost position or from the uppermost position to the lowermost position.

3. The wiper controlling method of claim 1, wherein the obtaining of the area includes obtaining a sum of an area of each of pulses of the PWM control signal by using a voltage, a duty cycle, and a cycle of the PWM control signal generated while the wiper moves in the pre-defined section.

4. The wiper controlling method of claim 1, wherein the obtaining of the area includes identifying a duty cycle of the PWM control signal for each predetermined time interval in the pre-defined section and accumulating a pulse area obtained based on the duty cycle identified for each predetermined time interval.

5. The wiper controlling method of claim 1, wherein the comparing of the area with the at least one pre-defined reference value includes identifying a windshield to be in a dry state when the area is greater than the at least one pre-defined reference value and identifying the windshield to be in a wet state when the area is equal to or less than the at least one pre-defined reference value.

6. The wiper controlling method of claim 1, wherein the controlling of the speed includes lowering the speed of the wiper when the area is greater than the at least one pre-defined reference value.

7. A wiper controlling apparatus comprising:
an area calculating unit configured to obtain an area of a Pulse Width Modulation (PWM) control signal generated for driving a wiper motor while a wiper moves in a pre-defined section;
a comparison unit configured to compare the area with at least one pre-defined reference value; and
a controlling unit configured to control a speed of the wiper based on a result of the comparison of the area with the at least one pre-defined reference value.

8. The wiper controlling apparatus of claim 7, wherein the area calculating unit is further configured to obtain a pulse area based on a duty cycle of the PWM control signal generated while the wiper moves from a lowermost position to an uppermost position or from the uppermost position to the lowermost position.

9. The wiper controlling apparatus of claim 7, wherein the area calculating unit is further configured to identify a duty cycle of the PWM control signal for each predetermined time interval in the pre-defined section and accumulate a pulse area obtained based on the duty cycle identified for each predetermined time interval.

10. The wiper controlling apparatus of claim 7, wherein the controlling unit is further configured to lower the speed of the wiper when the area is greater than the at least one pre-defined reference value.

11. The wiper controlling apparatus of claim 7, wherein the controlling unit is further configured to identify a windshield to be in a dry state when the area is greater than the at least one pre-defined reference value and identify the windshield to be in a wet state when the area is equal to or less than the at least one pre-defined reference value.

12. A computer-readable recording medium having recorded thereon a computer program for executing the method of claim 1.
